(19) United States
(12) Patent Application Publication
(10) Pub. No.: US 2026/0134515 A1
(43) Pub. Date: May 14, 2026

(54) VARIATIONAL AUTOENCODERS FOR HIGH-FIDELITY IMAGE-CONDITIONED GENERATION OR OTHER TASKS

(71) Applicant: Samsung Electronics Co., Ltd., Suwon-si (KR)

(72) Inventors: Yuhao Liu, Houston, TX (US); Weidi Liu, Frisco, TX (US); John Seokjun Lee, Allen, TX (US); Hamid R. Sheikh, Allen, TX (US)

(21) Appl. No.: 18/943,372

(22) Filed: Nov. 11, 2024

(51) Int. Cl. G06T 5/60; G06T 5/70

(52) U.S. Cl. CPC G06T 5/60; G06T 5/70; G06T 2207/20081

(57) ABSTRACT

A method includes training, using at least one processing device of an electronic device, a student variational autoencoder (VAE) based on a teacher VAE. Training the student VAE based on the teacher VAE includes using a first optimizer and a second optimizer. The first optimizer is configured to align a latent space of the student VAE with a latent space of the teacher VAE. The second optimizer is configured to optimize reconstruction performance of the student VAE. During use of the first optimizer, parameters of the teacher VAE may be frozen, and parameters of an encoder of the student VAE may be adjusted. During use of the second optimizer, the parameters of the encoder of the student VAE may be frozen, and parameters of a decoder of the student VAE may be adjusted.

### TECHNICAL FIELD

This disclosure relates generally to machine learning systems and processes. More specifically, this disclosure relates to variational autoencoders for high-fidelity image-conditioned generation or other tasks.

### BACKGROUND

Generative artificial intelligence/machine learning (AI/ML) models, such as diffusion models, have been widely adopted for performing various image synthesis tasks. For example, generative AI/ML models have been developed that can create realistic images based on textual inputs. These generative AI/ML models often require huge amounts of computational resources and huge amounts of training data in order to be trained properly. To reduce training costs and leverage existing AI/ML models, various techniques have been developed to modify pretrained foundational AI/ML models for specific generative tasks.

### SUMMARY

This disclosure relates to variational autoencoders (VAEs) for high-fidelity image-conditioned generation or other tasks.

In a first embodiment, a method includes training, using at least one processing device of an electronic device, a student VAE based on a teacher VAE. Training the student VAE based on the teacher VAE includes using a first optimizer and a second optimizer. The first optimizer is configured to align a latent space of the student VAE with a latent space of the teacher VAE. The second optimizer is configured to optimize reconstruction performance of the student VAE. A non-transitory machine-readable medium may include instructions that when executed cause at least one processor to perform the method of the first embodiment.

In a second embodiment, an apparatus includes at least one processing device configured to train a student VAE based on a teacher VAE. To train the student VAE based on the teacher VAE, the at least one processing device is configured to use a first optimizer and a second optimizer. The first optimizer is configured to align a latent space of the student VAE with a latent space of the teacher VAE. The second optimizer is configured to optimize reconstruction performance of the student VAE.

Any one or any combination of the following features may be used with the first or second embodiment. During use of the first optimizer while training the student VAE, parameters of the teacher VAE may be frozen, and parameters of an encoder of the student VAE may be adjusted using the first optimizer to minimize a loss between outputs of an encoder of the teacher VAE and outputs of the encoder of the student VAE. During use of the second optimizer while training the student VAE, the parameters of the encoder of the student VAE may be frozen, and parameters of a decoder of the student VAE may be adjusted using the second optimizer to minimize a loss between inputs to the encoder of the student VAE and outputs of the decoder of the student VAE. The first optimizer may be configured to minimize an L1 loss between the latent space of the student VAE and the latent space of the teacher VAE. The second optimizer may be configured to minimize a combination of an L1 loss and a divergence loss between the inputs to the encoder of the student VAE and the outputs of the decoder of the student VAE. Inputs to the teacher VAE may be up-sampled during the training of the student VAE, and the student VAE may have a common design as the teacher VAE but may lack at least one down-sampling operation that is included in the teacher VAE. After the training, the student VAE may be deployed for use with a generative artificial intelligence/machine learning (AI/ML) model. The student VAE and the AI/ML model may be used to perform image-conditioned generation (such as image restoration and/or low-light denoising) in order to generate output images based on input images.

In a third embodiment, a method includes processing an input image using an encoder of a VAE and providing an output of the encoder of the VAE to a generative AI/ML model. The method also includes performing an image-conditioned generation task using the generative AI/ML model and processing an output of the generative AI/ML model using a decoder of the VAE to generate an output image based on the input image. The VAE includes a student VAE that is trained based on a teacher VAE using a first optimizer and a second optimizer. The first optimizer is configured to align a latent space of the student VAE with a latent space of the teacher VAE. The second optimizer is configured to optimize reconstruction performance of the student VAE. An apparatus may include at least one processing device configured to perform the method of the third embodiment. A non-transitory machine-readable medium may include instructions that when executed cause at least one processor to perform the method of the third embodiment.

Any one or any combination of the following features may be used with the third embodiment. The first optimizer may be used to train the student VAE by freezing parameters of the teacher VAE and adjusting parameters of the encoder of the student VAE using the first optimizer to minimize a loss between outputs of an encoder of the teacher VAE and outputs of the encoder of the student VAE. The second optimizer may be used to train the student VAE by freezing the parameters of the encoder of the student VAE and adjusting parameters of the decoder of the student VAE using the second optimizer to minimize a loss between inputs to the encoder of the student VAE and outputs of the decoder of the student VAE. The first optimizer may be configured to minimize an L1 loss between the latent space of the student VAE and the latent space of the teacher VAE. The second optimizer may be configured to minimize a combination of an L1 loss and a divergence loss between the inputs to the encoder of the student VAE and the outputs of the decoder of the student VAE. Inputs to the teacher VAE may be up-sampled during the training of the student VAE, and the student VAE may have a common design as the teacher VAE but may lack at least one down-sampling operation that is included in the teacher VAE. The image-conditioned generation task may include image restoration and/or low-light denoising.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. §112(f).

### BRIEF DESCRIPTION OF THE DRAWINGS

For a more complete understanding of this disclosure and its advantages, reference is now made to the following description taken in conjunction with the accompanying drawings:

FIG. 1 illustrates an example network configuration including an electronic device in accordance with this disclosure;

FIG. 2 illustrates an example architecture that supports a variational autoencoder for high-fidelity image-conditioned generation or other task in accordance with this disclosure;

FIGS. 3A and 3B illustrate example stages of a training process for training a variational autoencoder for high-fidelity image-conditioned generation or other task in accordance with this disclosure;

FIGS. 4A through 4C illustrate example results obtainable using a variational autoencoder for high-fidelity image-conditioned generation or other task in accordance with this disclosure;

FIG. 5 illustrates an example method for training a variational autoencoder for high-fidelity image-conditioned generation or other task in accordance with this disclosure; and

FIG. 6 illustrates an example method for using a variational autoencoder for high-fidelity image-conditioned generation or other task in accordance with this disclosure.

### DETAILED DESCRIPTION

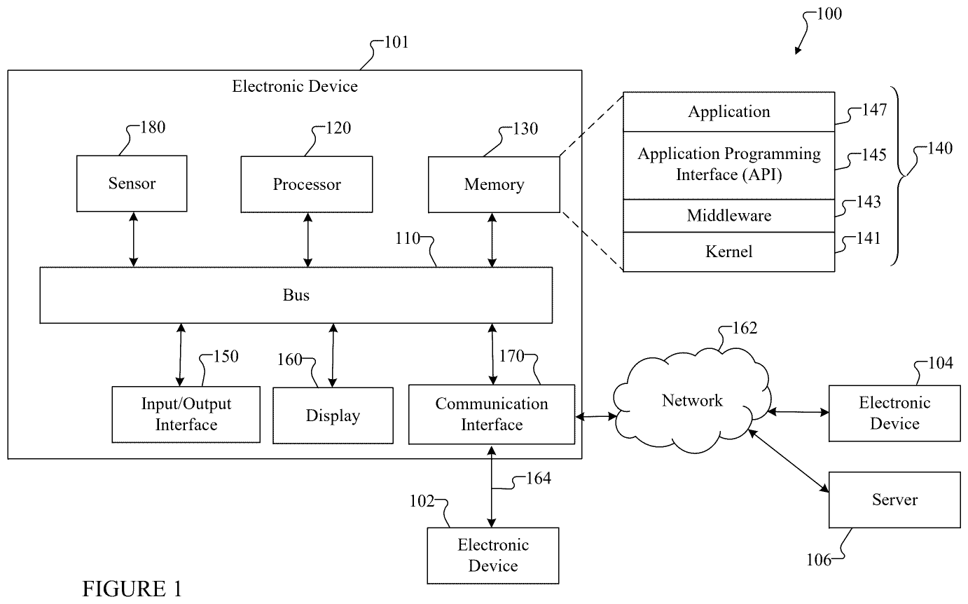

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure.

As noted above, generative artificial intelligence/machine learning (AI/ML) models, such as diffusion models, have been widely adopted for performing various image synthesis tasks. For example, generative AI/ML models have been developed that can create realistic images based on textual inputs. These generative AI/ML models often require huge amounts of computational resources and huge amounts of training data in order to be trained properly. To reduce training costs and leverage existing AI/ML models, various techniques have been developed to modify pretrained foundational AI/ML models for specific generative tasks.

Foundational generative AI/ML models used for image synthesis are often based on text-to-image synthesis. In other words, these generative AI/ML models can receive textual inputs (such as from users) and generate output images based on the textual inputs. However, there are some vision and imaging applications in which a generative AI/ML model should receive input images as input and generate output images based on the input images, and these generative AI/ML models are often said to be engaged in “image-conditioned generation.” Some approaches for image-conditioned generation have attempted to adopt pretrained text-to-image generative AI/ML models for use with specific image-conditioned generation tasks. Unfortunately, these approaches often result in the generation of clearly-visible artifacts in the output images, which may be due to things like hallucinated textures or poor image reconstructions.

One specific reason for the creation of these or other artifacts may be due to the fact that some generative AI/ML models (such as diffusion models) perform denoising operations in their latent feature spaces, and their latent feature spaces are typically heavily compressed by variational autoencoders (VAEs) associated with the AI/ML models. This heavy compression can result in a loss of image details in the resulting generated output images. As an example, in order to save computational space and time complexity, some AI/ML models are implemented as latent diffusion models (LDMs) in which denoising operations occur in a compressed latent feature space rather than in an original pixel or image space. Latent feature space compression is often achieved using a variational autoencoder, and the variational autoencoder often applies down-sampling (such as by a down-sampling factor of eight) to an AI/ML model's input data. This degree of compression typically does not pose an issue with respect to text-to-image synthesis in which textual input is converted into an output image. However, this degree of compression can become problematic when the AI/ML model's input data includes an image. Thus, for instance, an input image having dimensions of 256×256 in pixel space may be compressed to dimensions of 32×32 in a latent feature space. This heavy compression into the latent feature space can result in the generation of an output image having relatively poor quality, such as due to poor reconstruction or hallucinations.

Reducing the amount of latent feature space compression typically involves tuning a variational autoencoder. Training a new variational autoencoder to have a lower down-sampling factor is often trivially easy given adequate training data and computational resources. However, training a new variational autoencoder to have a lower down-sampling factor while remaining compatible with an existing diffusion model or other AI/ML model can be challenging. For example, an encoder in the new variational autoencoder typically needs to produce the same latent space manifold as the original variational autoencoder. If that does not occur, the resulting new variational autoencoder can produce an incompatible latent feature space that results in generated images being generally empty or blank. Existing training strategies typically try to optimize the overall reconstruction performance of an AI/ML model and do not explicitly regulate the latent space manifold of a variational autoencoder.

This disclosure provides various techniques related to variational autoencoders for high-fidelity image-conditioned generation or other tasks. As described in more detail below, a student variational autoencoder can be trained based on a teacher variational autoencoder. Training the student variational autoencoder based on the teacher variational autoencoder can include using a first optimizer and a second optimizer. The first optimizer can be configured to align a latent space of the student variational autoencoder with a latent space of the teacher variational autoencoder. For example, during use of the first optimizer, parameters of the teacher variational autoencoder may be frozen, and parameters of an encoder of the student variational autoencoder may be adjusted to minimize a loss between outputs of an encoder of the teacher variational autoencoder and outputs of the encoder of the student variational autoencoder. The second optimizer can be configured to optimize reconstruction performance of the student variational autoencoder. For instance, during use of the second optimizer, the parameters of the encoder of the student variational autoencoder may be frozen, and parameters of a decoder of the student variational autoencoder may be adjusted to minimize a loss between inputs to the encoder of the student variational autoencoder and outputs of the decoder of the student variational autoencoder. In some embodiments, inputs to the teacher variational autoencoder may be up-sampled during the training of the student variational autoencoder, and the student variational autoencoder may have a common design as the teacher variational autoencoder but may lack at least one down-sampling operation that is included in the teacher variational autoencoder.

After the training, the student variational autoencoder may be deployed for use with a generative AI/ML model. For example, an input image may be processed using the student variational autoencoder, and an output of the student variational autoencoder may be provided to a generative AI/ML model. An image-conditioned generation task may be performed using the generative AI/ML model, and an output of the generative AI/ML model may be processed using a decoder of the student variational autoencoder to generate an output image based on the input image. In some cases, the image-conditioned generation task may include image restoration and/or low-light denoising.

In this way, the described techniques support a new training strategy for training variational autoencoders to have one or more desired properties (such as a lower compression factor) while remaining compatible with diffusion models or other AI/ML models. This can help to avoid problems with incompatible latent spaces that might result in blank or other undesirable images being produced by the AI/ML models. Moreover, the described techniques can be used to explicitly regulate the latent space manifold of a variational autoencoder being trained. In addition, the described techniques can be used to achieve improved image-conditioned generation using diffusion models or other AI/ML models. The resulting variational autoencoders may be deployed for use in any suitable image-conditioned generation tasks or other tasks, such as super-resolution, low-light denoising, or other applications in which input images can be processed using the variational autoencoders and the AI/ML models. In some cases, performance of the image-conditioned generation task(s) may only involve training using appropriate data pairs without tuning of the actual AI/ML model backbone to achieve suitable performance.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may train and/or use a variational autoencoder for high-fidelity image-conditioned generation or other task(s).

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, train and/or use a variational autoencoder for high-fidelity image-conditioned generation or other task(s). These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may train and/or use a variational autoencoder for high-fidelity image-conditioned generation or other task(s).

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

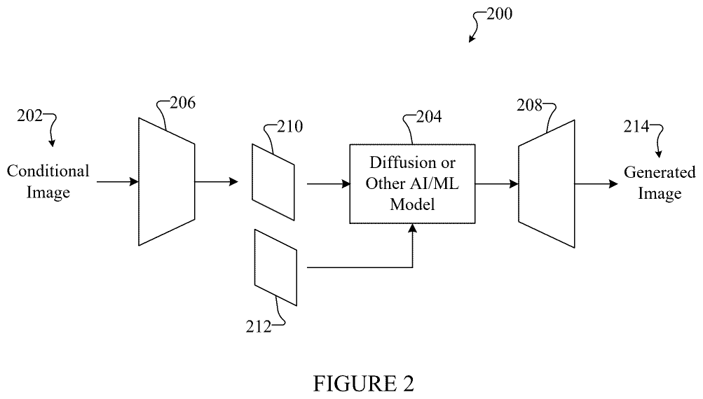

FIG. 2 illustrates an example architecture 200 that supports a variational autoencoder for high-fidelity image-conditioned generation or other task in accordance with this disclosure. For ease of explanation, the architecture 200 shown in FIG. 2 is described as being implemented on or supported by the electronic device 101 in the network configuration 100 shown in FIG. 1. However, the architecture 200 shown in FIG. 2 could be used with any other suitable device(s) and in any other suitable system(s), such as when the architecture 200 is implemented on or supported by the server 106.

As shown in FIG. 2, the architecture 200 generally receives a conditional image 202, which represents an input image to be processed by the architecture 200 during performance of at least one image-conditioned generation task. The conditional image 202 may represent any suitable image to undergo at least one image-conditioned generation task. The conditional image 202 may be obtained from any suitable source, such as when the conditional image 202 is generated by an electronic device 101 using at least one imaging sensor 180 or retrieved from a memory 130 of the electronic device 101. The conditional image 202 can also have any suitable format, such as a Bayer or other raw image format, a red-green-blue (RGB) image format, or a luma-chroma (YUV) image format. Raw image frames typically refer to image frames that have undergone little if any processing after being captured. The availability of raw image frames can be useful in a number of circumstances since the raw image frames can be subsequently processed to achieve the creation of desired effects in output images. The conditional image 202 can further have any suitable resolution, such as up to fifty megapixels or more.

The conditional image 202 is processed using a diffusion model or other AI/ML model 204 and a variational autoencoder (VAE) that includes an encoder 206 and a decoder 208. The encoder 206 receives the conditional image 202 and projects the conditional image 202 into a latent feature space. This effectively encodes the conditional image 202 in the latent feature space and creates an encoding of the conditional image 202 that is referred to as a latent condition 210. The latent condition 210 and a latent prior 212 are provided to the diffusion model or other AI/ML model 204. The latent prior 212 represents a statistical distribution that represents an initial assumption about the conditional image 202. The diffusion model or other AI/ML model 204 can process this information and generate output data in the latent feature space that is provided to the decoder 208. The decoder 208 decodes this information by projecting the information back into pixel or image space, thereby producing a generated image 214. The generated image 214 represents an output image that is created based on the conditional image 202 after the at least one image-conditioned generation task has been performed using the diffusion model or other AI/ML model 204.

The functionalities of the variational autoencoder and the AI/ML model 204 can vary depending on the specific use of the architecture 200, such as based on the at least one image-conditioned generation task being performed. As an example, the architecture 200 may be used to perform image restoration, such as a super-resolution function or other function in which image data is added to the conditional image 202 so that the resulting generated image 214 has a higher resolution than the conditional image 202. As another example, the architecture 200 may be used to perform low-light denoising, such as when noise in the conditional image 202 (often created due to low-light conditions during image capture) is removed and replaced with image data so that the resulting generated image 214 is a cleaner version of the conditional image 202.

The variational autoencoder that is used in the architecture 200 may be designed and trained as described below. For example, the variational autoencoder in the architecture 200 may represent a student variational autoencoder that is trained based on a teacher variational autoencoder, where the student variational autoencoder is trained to have the same or substantially the same latent feature space as the teacher variational autoencoder. This can be accomplished using two optimizers, where one optimizer aligns the latent spaces between the student and teacher variational autoencoders and the other optimizer optimizes an overall reconstruction performance of the student variational autoencoder. Among other things, this may allow for distillation training to train new variational autoencoders that are compatible with existing latent diffusion model backbones or other model backbones.

In some cases, inputs to the teacher variational autoencoder may be up-sampled during the training of the student variational autoencoder, and the student variational autoencoder may have the same structure/design as the teacher variational autoencoder but may lack at least one down-sampling operation that is included in the teacher variational autoencoder. Thus, for example, if the teacher variational autoencoder normally provides a down-sampling factor of eight, the inputs to the teacher variational autoencoder may be up-sampled by a factor of two, and the student variational autoencoder may lack a down-sampling operation from the teacher variational autoencoder that provides a down-sampling factor of two. This can allow the student variational autoencoder to provide for a reduced amount of down-sampling (meaning a reduced amount of compression) while remaining compatible with latent diffusion model backbones or other model backbones. Among other things, the student variational autoencoder can retain more local textural details in lower-resolution input images and can be used to achieve superior image quality in super-resolution tasks or other image-conditioned generation tasks.

It should be noted that this approach allows a framework that is adaptable to a wide range of image-conditioned generation tasks. That is, a student variational autoencoder may be designed and tuned for use with a specific image-conditioned generation task, such as super-resolution or low-light denoising. There may be little or no need to redesign or tune the underlying backbone of the diffusion model or other AI/ML model 204 based on the image-conditioned generation task(s) to be performed using the architecture 200.

Although FIG. 2 illustrates one example of an architecture 200 that supports a variational autoencoder for high-fidelity image-conditioned generation or other task, various changes may be made to FIG. 2. For example, various components or operations in FIG. 2 may be combined, further subdivided, replicated, rearranged, or omitted according to particular needs. Also, various additional components or functions may be used in FIG. 2.

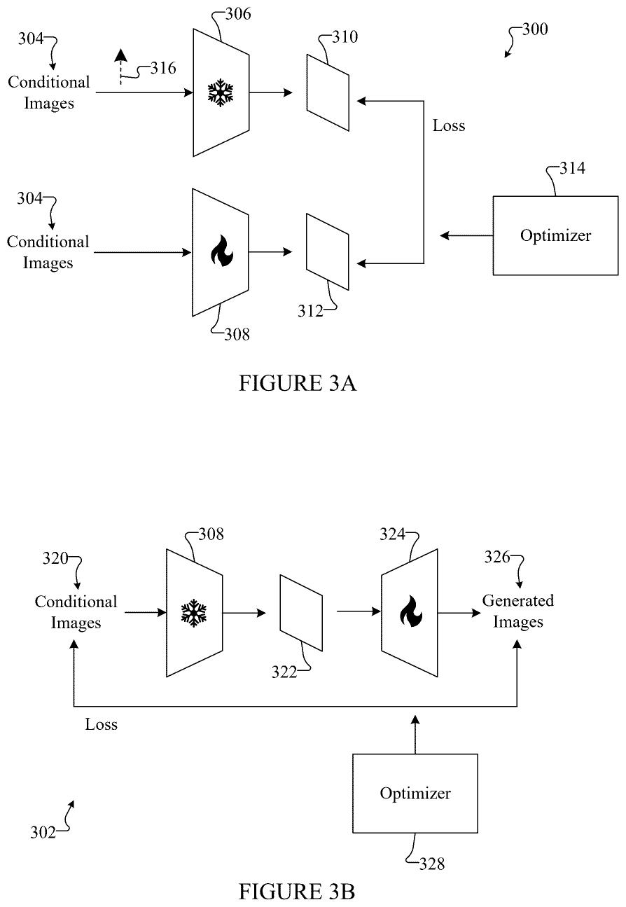

FIGS. 3A and 3B illustrate example stages 300 and 302 of a training process for training a variational autoencoder for high-fidelity image-conditioned generation or other task in accordance with this disclosure. For ease of explanation, the training process shown in FIGS. 3A and 3B may be described as being used to support the training of a variational autoencoder for use in the architecture 200 shown in FIG. 2. However, a trained variational autoencoder may be used in any other suitable architecture or environment. Also, for ease of explanation, the training process shown in FIGS. 3A and 3B may be described as being implemented on or supported by the server 106 in the network configuration 100 shown in FIG. 1. For instance, a variational autoencoder may be trained by the server 106 using the described training process, and the trained variational autoencoder may be deployed for use by the server 106, electronic device 101, or other device(s). However, the training process shown in FIGS. 3A and 3B could be used with any other suitable device(s) and in any other suitable system(s), such as when the training process is implemented on or supported by the electronic device 101.

As shown in FIG. 3A, during one stage 300 of the training process, conditional images 304 are provided to an encoder 306 of a teacher variational autoencoder and to an encoder 308 of a student variational autoencoder. In some cases, the encoder 308 may be trained for use as the encoder 206 in the architecture 200. During this stage 300 of the training process, parameters of the encoder 306 of the teacher variational autoencoder are frozen, meaning the parameters of the encoder 306 are not adjusted during this stage 300 of the training process. The conditional images 304 are processed by the encoder 306 to generate latent conditions 310, and the same conditional images 304 are processed by the encoder 308 to generate latent conditions 312.

Differences between the latent conditions 310, 312 can be used by an optimizer 314 to calculate a loss associated with the encoder 308. The optimizer 314 can also modify parameters of the encoder 308 during this stage 300 of the training process in order to reduce this loss. For example, the optimizer 314 may use back-propagation or other suitable machine learning technique to modify the parameters of the encoder 308. Over multiple training iterations, the encoder 308 becomes more and more effective at generating latent conditions 312 that more closely align with the latent conditions 310 produced by the encoder 306. Note that any suitable measure of loss may be used by the optimizer 314 here. In some embodiments, the optimizer 314 identifies an L1 loss, which is also known as a mean absolute error (MAE) loss, between the latent conditions 310, 312.

The overall effect of this stage 300 of the training process may be that the latent space defined by the encoder 308 of the student variational autoencoder becomes more closely aligned with the latent space defined by the encoder 306 of the teacher variational autoencoder. That is, the encoder 308 of the student variational autoencoder is trained to generate latent conditions 312 within the same general latent features space as the encoder 306 of the teacher variational autoencoder. In some cases, the teacher variational autoencoder may represent a native variational autoencoder that is designed for use with a specific diffusion model or other AI/ML model 204. Among other things, this approach can help to ensure that the encoder 308 of the student variational autoencoder is trained in a manner that makes the student variational autoencoder compatible for use with the specific diffusion model or other AI/ML model 204.

As shown in FIG. 3B, during another stage 302 of the training process, conditional images 320 are provided to the encoder 308 of the student variational autoencoder. The encoder 308 generates latent conditions 322 based on each of the conditional images 320, and the latent conditions 322 are provided to a decoder 324 of the student variational autoencoder. In some cases, the decoder 324 may be trained for use as the decoder 208 in the architecture 200. During this stage 302 of the training process, parameters of the encoder 308 of the student variational autoencoder are frozen, meaning the parameters of the encoder 308 are not adjusted during this stage 302 of the training process. The latent conditions 322 are processed by the decoder 324 to produce generated images 326 corresponding to the conditional images 320.

Since the latent conditions 322 are not modified by a diffusion model or other AI/ML model 204 during this stage 302 of the training process, the decoder 324 is being trained here to produce generated images 326 that match or substantially match the conditional images 320. Differences between the conditional images 320 and the generated images 326 can be used by an optimizer 328 to calculate a loss associated with the decoder 324. The optimizer 328 can also modify parameters of the decoder 324 during this stage 302 of the training process to reduce this loss. For example, the optimizer 328 may use back-propagation or other suitable machine learning techniques to modify the parameters of the decoder 324. Over multiple training iterations, the decoder 324 becomes more and more effective at producing generated images 326 that match the conditional images 320. Note that any suitable measure of loss may be used by the optimizer 328 here. In some embodiments, the optimizer 328 identifies a combination of an L1 loss and a divergence loss between the conditional images 320 and the generated images 326. The divergence loss may define how well probability distributions of the conditional images 320 and the generated images 326 match one another. In particular embodiments, the divergence loss could represent a Kullback-Keibler (K-L) loss.

The overall effect of this stage 302 of the training process may be that the reconstruction performance of the decoder 324 of the student variational autoencoder improves, meaning the decoder 324 becomes more effective or accurate in reconstructing images based on latent conditions. Because of this, the decoder 324 can be trained to accurately produce generated images 326 that achieve desired results, such as by producing generated images 326 that have higher resolutions compared to the associated conditional images 320 and/or that are cleaner (less noisy) relative to their associated conditional images 320.

In some embodiments, the stages 300 and 302 of the training process may be performed iteratively. In other words, the stages 300 and 302 of the training process may be performed repeatedly by switching back and forth between performing the stage 300 of the training process and performing the stage 302 of the training process. As a result, both the encoder 308 and the decoder 324 of the student variational autoencoder become more and more effective at their respective functions.

The training process described above supports the training of student variational autoencoders that achieve one or more desired properties. For image-conditioned generation, one desired property may be a lower down-sampling factor, which can help to reduce compression artifacts. In order to achieve this reduction in the down-sampling factor, in some embodiments, the stage 300 of the training process may include an optional up-sampling operation 316. The up-sampling operation 316 increases the number of samples and thereby increases the resolution of the conditional images 304 provided to the encoder 306 of the teacher variational autoencoder. The up-sampling operation 316 may use any suitable technique to up-sample data, such as bilinear interpolation. Here, the student variational autoencoder can have the same design as the teacher variational autoencoder, but the encoder 308 of the student variational autoencoder may omit or lack at least one down-sampling operation that is included in the encoder 306 of the teacher variational autoencoder. The overall effect of this approach is that the encoder 308 of the student variational autoencoder is still trained to match or substantially match the latent feature space of the encoder 306 of the teacher variational autoencoder, but the encoder 308 of the student variational autoencoder provides less down-sampling than the encoder 306 of the teacher variational autoencoder. Thus, for instance, the encoder 306 of the teacher variational autoencoder could operate by providing a down-sampling factor of eight, but the encoder 308 of the student variational autoencoder may operate by providing a down-sampling factor of four (while still being compatible with the backbone of a diffusion model or other AI/ML model 204).

Although FIGS. 3A and 3B illustrate examples of stages 300 and 302 of a training process for training a variational autoencoder for high-fidelity image-conditioned generation or other task, various changes may be made to FIGS. 3A and 3B. For example, various components or operations in each of FIGS. 3A and 3B may be combined, further subdivided, replicated, rearranged, or omitted according to particular needs. Also, various additional components or functions may be used in each of FIGS. 3A and 3B.

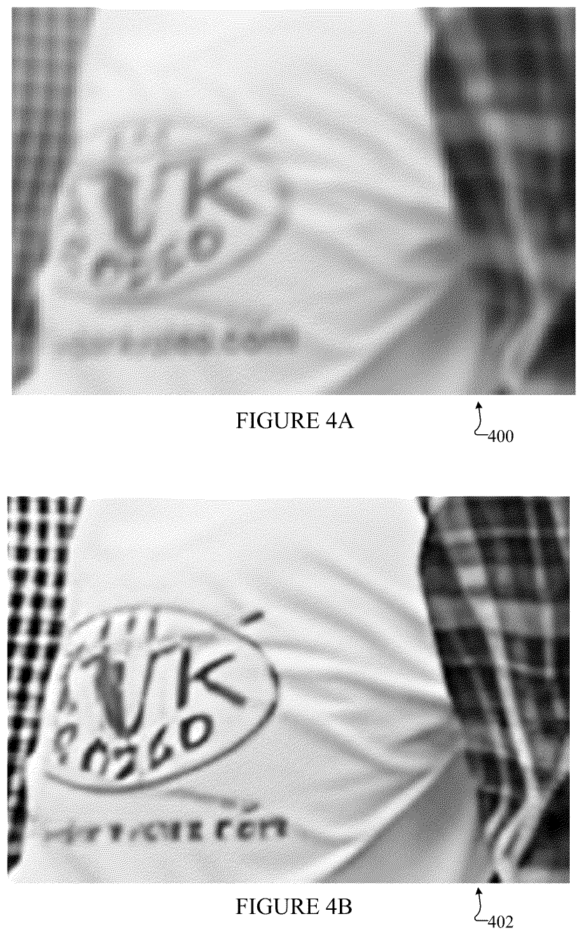

FIGS. 4A through 4C illustrate example results obtainable using a variational autoencoder for high-fidelity image-conditioned generation or other task in accordance with this disclosure. More specifically, FIG. 4A illustrates part of an example input image 400 that could be subjected to an image-conditioned generation task. The input image 400 is generally considered to be a lower-resolution image, and certain contents of the input image 400 can appear blurry or noisy. In some cases, the image-conditioned generation task may represent a super-resolution task that is designed to increase the resolution and therefore the clarity of the input image 400.

FIG. 4B illustrates part of an example output image 402 generated using a diffusion model (such as a Stable Diffusion model) and a standard variational autoencoder that is not designed or trained as described above. As can be seen here, even though the output image 402 has an increased resolution relative to the input image 400, the results do not appear natural. For example, the center portion of the text appears unnaturally sharp given that the surrounding text is softer and less in focus.

FIG. 4C illustrates part of an example output image 404 generated using a diffusion model or other AI/ML model 204 and a variational autoencoder that is designed and trained as described above. As can be seen here, the resulting output image 404 provides results that appear much more natural. For example, the output image 404 is sharper and includes image data that is much more faithful to the original details of the input image 400. However, the output image 404 does not appear artificially sharpened in small areas of the output image 404.

Although FIGS. 4A through 4C illustrate one example of results obtainable using a variational autoencoder for high-fidelity image-conditioned generation or other task, various changes may be made to FIGS. 4A through 4C. For example, FIGS. 4A through 4C are merely meant to illustrate one example of a type of benefit that might be obtained using the techniques of this disclosure. The specific results that are obtained in any given situation can vary based on the circumstances and based on the specific implementation of the techniques described in this disclosure. As a particular example, the type of results obtained during low-light denoising can differ from the type of results obtained during super-resolution.

Note that the functionality described above may be used in various applications or use cases. For example, a variational autoencoder may be trained as shown in FIGS. 3A and 3B and deployed to the architecture 200 as shown in FIG. 2 for any number of purposes. Example purposes may include super-resolution, low-light denoising, and other image-conditioned generation tasks. The resulting images that are generated may also be used for any suitable purposes. As a particular example, the resulting images may be generated by an electronic device 101 based on images captured by the electronic device 101, and improved versions of the captured images may be stored or displayed by the electronic device 101. As another particular example, images can be processed using the architecture 200 to generate high-quality datasets that could be used for various image processing tasks, such as multi-frame processing, video processing, or general image restoration tasks. The high-quality datasets can also or alternatively be used as ground truth data for various computational imaging tasks where high-quality ground truth images may not be easily obtainable or accessible.

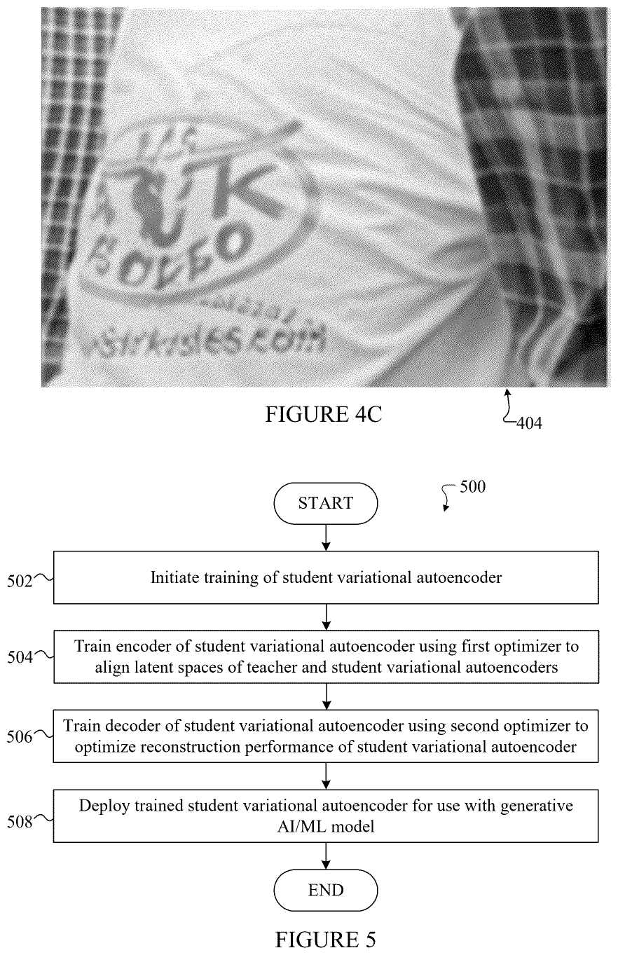

FIG. 5 illustrates an example method 500 for training a variational autoencoder for high-fidelity image-conditioned generation or other task in accordance with this disclosure. For ease of explanation, the method 500 shown in FIG. 5 is described as being performed by the server 106 in the network configuration 100 shown in FIG. 1, where the server 106 can implement the training process shown in FIGS. 3A and 3B. However, the method 500 shown in FIG. 5 could be performed by any other suitable device(s) and in any other suitable system(s), such as when the method 500 is performed using the electronic device 101.

As shown in FIG. 5, training of a student variational autoencoder is initiated at step 502. This may include, for example, the processor 120 of the server 106 obtaining information defining the encoder 306 of a teacher variational autoencoder to be used during the training process and information defining the encoder 308 and decoder 324 of a student variational autoencoder to be trained during the training process. This may also include the processor 120 of the server 106 obtaining conditional images 304, 320 to be provided to the teacher and student variational autoencoders during the training process.

The encoder of the student variational autoencoder is trained using a first optimizer to align the latent feature spaces of the teacher and student variational autoencoders at step 504. This may include, for example, the processor 120 of the server 106 providing at least some of the conditional images 304 to the encoders 306, 308 and generating latent conditions 310, 312 using the encoders 306, 308. This may also include the processor 120 of the server 106 using the optimizer 314 to identify a loss (such as an L1 loss) between the latent conditions 310 generated using the encoder 306 and the latent conditions 312 generated using the encoder 308. This may further include the processor 120 of the server 106 using the optimizer 314 to modify parameters of the encoder 308 of the student variational autoencoder in order to try and reduce the calculated loss.

The decoder of the student variational autoencoder is trained using a second optimizer to optimize the reconstruction performance of the student variational autoencoder at step 506. This may include, for example, the processor 120 of the server 106 providing at least some of the conditional images 320 to the encoder 308 and generating latent conditions 322 using the encoder 308. This may also include the processor 120 of the server 106 providing the latent conditions 322 to the decoder 324 and producing generated images 326 based on the latent conditions 322. This may further include the processor 120 of the server 106 using the optimizer 328 to identify a loss (such as a combination of an L1 loss and a K-L or other divergence loss) between the conditional images 320 and the generated images 326. In addition, this may include the processor 120 of the server 106 using the optimizer 328 to modify parameters of the decoder 324 of the student variational autoencoder in order to try and reduce the calculated loss.

As noted above, these two stages of the training process may be performed iteratively and in any suitable order. Thus, for example, steps 504 and 506 may be performed multiple times by switching back-and-forth between training of the encoder 308 of the student variational autoencoder during step 504 and training of the decoder 324 of the student variational autoencoder during step 506. Over time, both losses determined by the first and second optimizers 314 and 328 decrease as (i) the latent feature space of the encoder 308 more closely aligns with the latent feature space of the encoder 306 and (ii) the reconstruction performance of the student variational autoencoder improves. The number of repetitions or iterations of the training stages 300 and 302 may be controlled in any suitable manner, such as by repeating the iterations of the training stages 300 and 302 until both losses achieve suitably low values, until a specified number of iterations have occurred, or until a specified amount of training time has elapsed. Also, as noted above, step 504 may optionally include up-sampling the conditional images 304 provided to the encoder 306 of the teacher variational autoencoder. As described above, in these embodiments, the student variational autoencoder may have a common design as the teacher variational autoencoder, but the encoder 308 of the student variational autoencoder may lack at least one down-sampling operation that is included in the encoder 306 of the teacher variational autoencoder.

Once trained, the student variational autoencoder can be deployed for use with a generative AI/ML model at step 508. This may include, for example, the processor 120 of the server 106 placing the trained student variational autoencoder into use, such as in one or more instances of the architecture 200 supported by the server 106. This may also or alternatively include the processor 120 of the server 106 providing the trained student variational autoencoder to at least one other device (such as the electronic device 101) that supports one or more instances of the architecture 200.

Although FIG. 5 illustrates one example of a method 500 for training a variational autoencoder for high-fidelity image-conditioned generation or other task, various changes may be made to FIG. 5. For example, while shown as a series of steps, various steps in FIG. 5 may overlap, occur in parallel, occur in a different order, or occur any number of times (including zero times). As a particular example, steps 504 and 506 may occur any number of times in an iterative manner as discussed above.

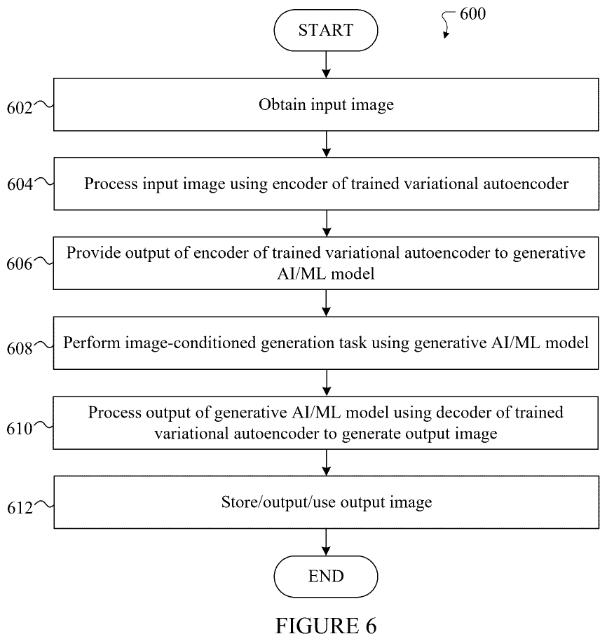

FIG. 6 illustrates an example method 600 for using a variational autoencoder for high-fidelity image-conditioned generation or other task in accordance with this disclosure. For ease of explanation, the method 600 shown in FIG. 6 is described as being performed by the electronic device 101 in the network configuration 100 shown in FIG. 1, where the electronic device 101 can implement the architecture 200 shown in FIG. 2. However, the method 600 shown in FIG. 6 could be performed by any other suitable device(s) and architecture(s) and in any other suitable system(s), such as when the method 600 is performed using the server 106.

As shown in FIG. 6, an input image is obtained at step 602. This may include, for example, the processor 120 of the electronic device 101 obtaining a conditional image 202 to be processed. The conditional image 202 may be captured using at least one imaging sensor 180 of the electronic device 101, retrieved from a memory 130 of the electronic device 101, or obtained in any other suitable manner.

The input image is processed using an encoder of a trained variational autoencoder at step 604. This may include, for example, the processor 120 of the electronic device 101 processing the conditional image 202 using an encoder 206 of the trained variational autoencoder. In some cases, the encoder 206 may represent an encoder 308 of a student variational autoencoder that is trained as described above. The output of the encoder of the trained variational autoencoder is provided to a generative AI/ML model at step 606, and at least one image-conditioned generation task is performed using the generative AI/ML model at step 608. This may include, for example, the processor 120 of the electronic device 101 providing the latent condition 210 generated by the encoder 206 to a diffusion model or other AI/ML model 204. This may also include the processor 120 of the electronic device 101 performing a super-resolution task, low-light denoising task, or other image-conditioned generation task(s) using the diffusion model or other AI/ML model 204. An output of the generative AI/ML model is processed using a decoder of the trained variational autoencoder to generate an output image at step 610. This may include, for example, the processor 120 of the electronic device 101 processing the output of the generative AI/ML model 204 using a decoder 208 of the trained variational autoencoder in order to produce a generated image 214. In some cases, the decoder 208 may represent a decoder 324 of the student variational autoencoder that is trained as described above.

The output image may be stored, output, or used in some manner at step 612. For example, the generated image 214 may be displayed on the display 160 of the electronic device 101, saved to a camera roll stored in a memory 130 of the electronic device 101, or attached to a text message, email, or other communication to be transmitted from the electronic device 101. Of course, the generated image 214 could be used in any other or additional manner.

Although FIG. 6 illustrates one example of a method 600 for using a variational autoencoder for high-fidelity image-conditioned generation or other task, various changes may be made to FIG. 6. For example, while shown as a series of steps, various steps in FIG. 6 may overlap, occur in parallel, occur in a different order, or occur any number of times (including zero times).

It should be noted that the functions described above can be implemented in an electronic device 101, 102, 104, server 106, or other device(s) in any suitable manner. For example, in some embodiments, at least some of the functions can be implemented or supported using one or more software applications or other software instructions that are executed by the processor 120 of the electronic device 101, 102, 104, server 106, or other device(s). In other embodiments, at least some of the functions can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
training, using at least one processing device of an electronic device, a student variational autoencoder (VAE) based on a teacher VAE, wherein training the student VAE based on the teacher VAE comprises using a first optimizer and a second optimizer;
wherein the first optimizer is configured to align a latent space of the student VAE with a latent space of the teacher VAE; and
wherein the second optimizer is configured to optimize reconstruction performance of the student VAE.

2. The method of claim 1, wherein, during use of the first optimizer while training the student VAE:
parameters of the teacher VAE are frozen; and
parameters of an encoder of the student VAE are adjusted using the first optimizer to minimize a loss between outputs of an encoder of the teacher VAE and outputs of the encoder of the student VAE.

3. The method of claim 2, wherein, during use of the second optimizer while training the student VAE:
the parameters of the encoder of the student VAE are frozen; and
parameters of a decoder of the student VAE are adjusted using the second optimizer to minimize a loss between inputs to the encoder of the student VAE and outputs of the decoder of the student VAE.

4. The method of claim 3, wherein:
the first optimizer is configured to minimize an L1 loss between the latent space of the student VAE and the latent space of the teacher VAE; and
the second optimizer is configured to minimize a combination of an L1 loss and a divergence loss between the inputs to the encoder of the student VAE and the outputs of the decoder of the student VAE.

5. The method of claim 1, further comprising:
up-sampling inputs to the teacher VAE during the training of the student VAE;
wherein the student VAE has a common design as the teacher VAE but lacks at least one down-sampling operation that is included in the teacher VAE.

6. The method of claim 1, further comprising:
after the training, deploying the student VAE for use with a generative artificial intelligence/machine learning (AI/ML) model.

7. The method of claim 6, further comprising:
using the student VAE and the AI/ML model to perform image-conditioned generation in order to generate output images based on input images.

8. An apparatus comprising:
at least one processing device configured to train a student variational autoencoder (VAE) based on a teacher VAE, wherein, to train the student VAE based on the teacher VAE, the at least one processing device is configured to use a first optimizer and a second optimizer;
wherein the first optimizer is configured to align a latent space of the student VAE with a latent space of the teacher VAE; and
wherein the second optimizer is configured to optimize reconstruction performance of the student VAE.

9. The apparatus of claim 8, wherein, during use of the first optimizer while training the student VAE, the at least one processing device is configured to:
freeze parameters of the teacher VAE; and
adjust parameters of an encoder of the student VAE using the first optimizer to minimize a loss between outputs of an encoder of the teacher VAE and outputs of the encoder of the student VAE.

10. The apparatus of claim 9, wherein, during use of the second optimizer while training the student VAE, the at least one processing device is configured to:
freeze the parameters of the encoder of the student VAE; and
adjust parameters of a decoder of the student VAE using the second optimizer to minimize a loss between inputs to the encoder of the student VAE and outputs of the decoder of the student VAE.

11. The apparatus of claim 10, wherein:
the first optimizer is configured to minimize an L1 loss between the latent space of the student VAE and the latent space of the teacher VAE; and
the second optimizer is configured to minimize a combination of an L1 loss and a divergence loss between the inputs to the encoder of the student VAE and the outputs of the decoder of the student VAE.

12. The apparatus of claim 8, wherein:
the at least one processing device is further configured to up-sample inputs to the teacher VAE during the training of the student VAE; and
the student VAE has a common design as the teacher VAE but lacks at least one down-sampling operation that is included in the teacher VAE.

13. The apparatus of claim 8, wherein the at least one processing device is further configured, after the training, to deploy the student VAE for use with a generative artificial intelligence/machine learning (AI/ML) model.

14. The apparatus of claim 13, wherein the at least one processing device is further configured to use the student VAE and the AI/ML model to perform image-conditioned generation in order to generate output images based on input images.

15. A method comprising:
processing an input image using an encoder of a variational autoencoder (VAE);
providing an output of the encoder of the VAE to a generative artificial intelligence/ machine learning (AI/ML) model;
performing an image-conditioned generation task using the generative AI/ML model; and
processing an output of the generative AI/ML model using a decoder of the VAE to generate an output image based on the input image;
wherein the VAE comprises a student VAE that is trained based on a teacher VAE using a first optimizer and a second optimizer;
wherein the first optimizer is configured to align a latent space of the student VAE with a latent space of the teacher VAE; and
wherein the second optimizer is configured to optimize reconstruction performance of the student VAE.

16. The method of claim 15, wherein the first optimizer is used to train the student VAE by:
freezing parameters of the teacher VAE; and
adjusting parameters of the encoder of the student VAE using the first optimizer to minimize a loss between outputs of an encoder of the teacher VAE and outputs of the encoder of the student VAE.

17. The method of claim 16, wherein the second optimizer is used to train the student VAE by:
freezing the parameters of the encoder of the student VAE; and
adjusting parameters of the decoder of the student VAE using the second optimizer to minimize a loss between inputs to the encoder of the student VAE and outputs of the decoder of the student VAE.

18. The method of claim 17, wherein:
the first optimizer is configured to minimize an L1 loss between the latent space of the student VAE and the latent space of the teacher VAE; and
the second optimizer is configured to minimize a combination of an L1 loss and a divergence loss between the inputs to the encoder of the student VAE and the outputs of the decoder of the student VAE.

19. The method of claim 15, wherein:
inputs to the teacher VAE are up-sampled during the training of the student VAE; and
the student VAE has a common design as the teacher VAE but lacks at least one down-sampling operation that is included in the teacher VAE.

20. The method of claim 15, wherein the image-conditioned generation task comprises at least one of: image restoration and low-light denoising.
